(19) United States
(12) Patent Application Publication
(10) Pub. No.: US 2017/0266921 A1
(43) Pub. Date: Sep. 21, 2017

(54) NOVEL LAYERED MATERIALS AND THEIR USE

(71) Applicant: SURFACTOR GERMANY GMBH, Essen (DE)

(72) Inventors: Juha LIPPONEN, Kitee (FI); Ilpo SILVENTOINEN, Kesaelahti (FI)

(73) Assignee: Surfactor Germany GmbH, Essen (DE)

(21) Appl. No.: 15/532,102

(22) PCT Filed: Dec. 3, 2015
(86) PCT No.: PCT/EP2015/078539

§ 371 Date: Jun. 1, 2017

(30) Foreign Application Priority Data
Dec. 3, 2014 (EP) 14004072.6

(51) Int. Cl. B32B 11/00; B32B 38/08; C08G 65/329; C08G 65/333; D06N 5/00; C08K 5/09; C08K 5/1539; C08L 95/00; C09D 195/00; B32B 33/00; C08K 5/07

(52) U.S. Cl. CPC B32B 11/00; B32B 33/00; B32B 38/08; C08G 65/329; C08G 65/333; C08K 5/07; C08K 5/09; C08K 5/1539; C08L 95/00; C09D 195/00; D06N 5/003; B32B 21/02

(57) ABSTRACT

A layered material includes a first carrier material and a second carrier material. The first carrier material is coated or saturated with a modified bitumen. The modified bitumen is a bitumen to which is added an agent selected from a wax, a silicone oil, stearic acid, alkene ketene dimer (AKD), alkenyl succinic anhydride (ASA), and mixtures thereof. The first carrier material is continuously attached to the second carrier material.

### CROSS REFERENCE TO PRIOR APPLICATIONS

This application is a U.S. National Phase application under 35 U.S.C. §371 of International Application No. PCT/EP2015/078539, filed on Dec. 3, 2015 and which claims benefit to European Patent Application No. 14004072.6, filed on Dec. 3, 2014. The International Application was published in English on Jun. 9, 2016 as WO 2016/087591 A1 under PCT Article 21(2).

### FIELD

The present invention relates to layered materials, in particular to a composite, with improved properties.

### BACKGROUND

Various methods in the treatment and coating of wood products (such as plywood, chip-board, fiber board and OSB products and the like) are known. The coatings often comprise resin with different additives. Phenolic resin, amino resin or equivalent resins or mixtures thereof are typically used.

The service value of wood products such as wood-based panels is reduced if holes appear in the coating resulting from processing, storage, or use. In this case, the wood product could easily absorb moisture from the air or water, for example, from wet concrete in connection with casting. From the holes, the moisture can easily spread in the direction of the wood grains and cause local swelling of the grains, i.e., rippling, and thereby blistering of the surface of the wood product. Blistering is often accompanied by a reduced adhesion as well as an increased risk of cracking of respective wood product surfaces leading to wood products with significantly reduced service durability and undesirable appearance.

### SUMMARY

An aspect of the present invention is to mitigate at least one of the above drawbacks. An aspect of the present invention is in particular to provide a novel method for treating wood products to provide wood boards of improved quality, in particular wood products having improved surface properties.

In an embodiment, the present invention provides a layered material which includes a first carrier material and a second carrier material. The first carrier material is coated or saturated with a modified bitumen. The modified bitumen is a bitumen to which is added an agent selected from a wax, a silicone oil, stearic acid, alkene ketene dimer (AKD), alkenyl succinic anhydride (ASA), and mixtures thereof. The first carrier material is continuously attached to the second carrier material.

### BRIEF DESCRIPTION OF THE DRAWINGS

The present invention is described in greater detail below on the basis of embodiments and of the drawings in which:

FIG. 1: shows: (A) a schematic drawing of a component of the layered material according to the present invention showing a cross-section with the first carrier material (3), an intermediate bitumen layer of the modified bitumen, (2) and an overlaying resin layer (1); and, (B) a schematic drawing of a component of the layered material according to the present invention showing a cross-section with an intermediate first carrier material (3), the overlying bitumen layer of the modified bitumen (2) and a lower resin layer (1);

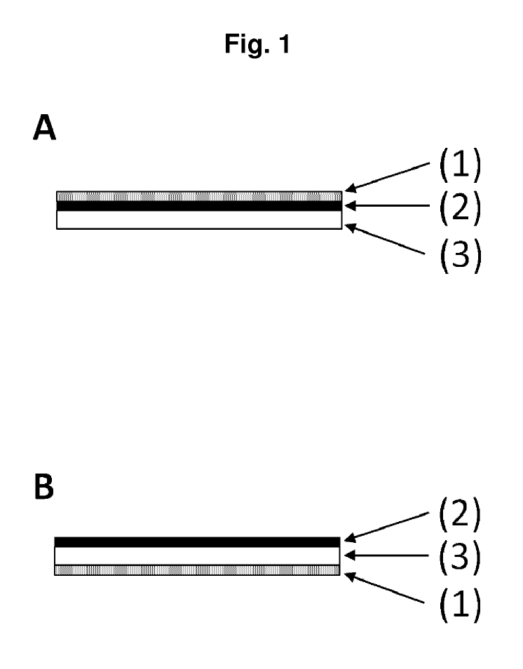

FIG. 2: shows: (A) a schematic drawing of a component of the layered material according to the present invention showing a cross-section with a central first carrier material (3), an overlaying bitumen layer of the modified bitumen (2) and two outermost resin layers (1); (B) a schematic drawing of a component of the layered material according to the present invention showing a cross-section with an intermediate first carrier material (3), coated on each side with a bitumen layer of the modified bitumen (2) and further exhibiting an outer resin layer (1); and, (C) a schematic drawing of a component of the layered material according to the present invention showing a cross-section with an intermediate first carrier material (3), coated on each side with a bitumen layer of the modified bitumen (2) and further exhibiting two outermost resin layers (1);

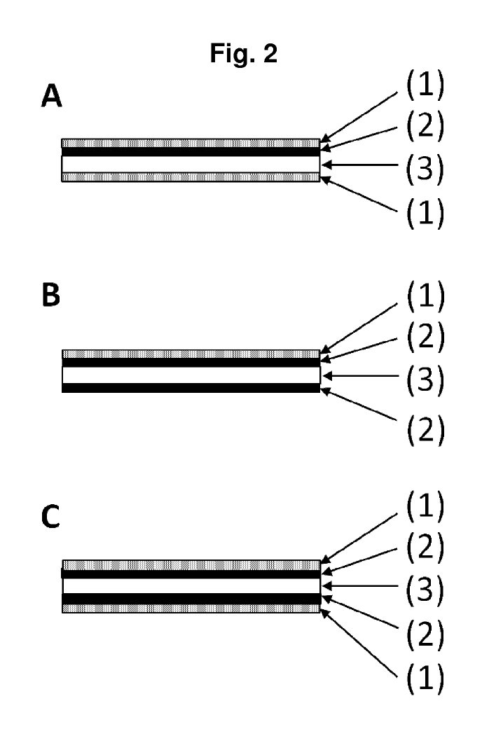

FIG. 3: shows: (A) a schematic drawing showing a cross-section of a layered material according to the present invention with a first carrier material saturated with the modified bitumen (2), an overlaying outermost resin layer (3), and a second carrier material (1); (B) a schematic drawing showing a cross-section of a layered material according to the present invention with a first carrier material (2b) coated on each side with the modified bitumen (2a), an overlaying outermost resin layer (3), and a second carrier material (1); (C) a schematic drawing showing a cross-section of a layered material according to the present invention with a first carrier material saturated with the modified bitumen (2), coated on each side with a resin layer (3), and a second carrier material (1); and, (D) a schematic drawing showing a cross-section of a layered material according to the present invention with a first carrier material saturated with the modified bitumen (2), coated on each side with a resin layer with an additional outermost resin layer (3), and a second carrier material (1).

### DETAILED DESCRIPTION

The inventors have found that a layered material comprising a first carrier material with a modified bitumen and a second carrier material, wherein the first carrier material and the second carrier material are continuously attached to each other, is particularly suitable for treating, composing and processing wood products. According to the present invention, the bitumen is modified by adding an agent selected from the group consisting of wax, in particular paraffin, silicone oil, stearic acid, alkene ketene dimer (AKD), alkenyl succinic anhydride (ASA), and mixtures thereof. The bitumen according to the present invention is hereinafter also called “modified bitumen”.

The attachment of the first carrier material and the second carrier material can occur either directly or indirectly, indirectly meaning that one or more further layers can form intermediate layers between the first and the second carrier material. In such embodiments, the first carrier material and the second carrier material are not directly in contact. In an embodiment of the present invention, the first carrier material and the second carrier material can, for example, form a composite material.

Coating or saturating the first carrier material with the modified bitumen (bitumization) allows for improved surface properties of the resulting layered material, which can, for example, be a wood product. The term “surface properties” used according to the present invention refers to properties which are of particular importance for the quality and service durability of surface structures and coatings in general, especially wood surface structures, and includes cracking, adherence and water resistance, i.e., in particular rippling.

The inventors found that a bitumen which is modified with an agent selected from the group consisting of wax, in particular paraffin, silicone oil, stearic acid, alkene ketene dimer (AKD), alkenyl succinic anhydride (ASA) and mixtures thereof unexpectedly provided layered materials of superior quality, especially layered materials providing further improved surface properties, in particular further increased water resistance and adhesion. The resulting layered materials thus allow for an increased service durability of resulting wood products even under harsh conditions of handling and use while maintaining the desired appearance.

In an embodiment of the present invention, a reduction of rippling, in particular of the second carrier material, of usually at least 25%, for example, of at least 30%, for example, of at least 40% and, in particular, for example, of at least 50% is obtainable with the layered materials using a modified bitumen according to the present invention. A reduction in rippling of, for example, at least 60%, and, for example, of at least 70% and, for example, of at least 80% is obtainable with the layered materials using a modified bitumen according to the present invention. Rippling can be evaluated by measuring the length of swollen fibers (whiskers) around a hole within the layered material with a depth of at least 0.5 mm after applying a wet paper towel or cloth on top of the hole for at least 2 hours, wherein the paper towel or cloth is kept wet during the test. The obtained result is given as the length in mm of swelled wood grains around the hole: (diameter of the swelling area−diameter of the hole)=rippling result. Reduction of rippling can be measured by calculating the rippling of the layered material according to the present invention compared to a reference sample on the same piece of plywood as a second carrier material. Reduced rippling reduces the risk of cracking of the surface in case the wood surface is damaged and the layered material, in particular the second carrier material such as a wood-based panel or a wood-based veneer, is exposed to moisture. The service life of resulting wood product is increased due to less swelling and shrinkage caused by cyclic moisture exposure.

According to the present invention, the modified bitumen applied to the first carrier material can act as a blocking layer which reduces or prevents moisture transfer. Adhesion of the components of the layered material according to the present invention, especially adhesion between the first carrier material and the second carrier material, can also be improved and cracking can be reduced by using the modified bitumen when composing, processing or treating the wood products.

The bitumization of the first carrier material can also result in an advantageous flexibility of the layered material according to the present invention. It can increase the strength during drying and later handling and use of the resulting wood product, such as veneer product, but at the same time the wood product can remain sufficiently flexible. It can be handled with a substantially reduced risk of ruptures.

The layered material of the present invention can also exhibit an improved resistance against chemicals.

It was also found by the inventors that modified bitumen is compatible with resins, in particular synthetic resins. Synthetic Resins are commonly used in the production of wood products, in particular phenolic or formaldehyde-based resins. In an embodiment of the present invention, the layered material of the present invention can therefore, for example, further comprise a synthetic resin. The synthetic resin can be applied in a mixture together with the modified bitumen or in a separate step. It can then form a resin layer.

Due to its compatibility with synthetic resin compositions, the bitumen can be used to partly or even completely substitute the synthetic resin (such as phenolic or formaldehyde-based resins) within the layered material according to the present invention. The latter is accompanied by reduced production costs and can further facilitate processing.

According to the present invention, a layered material is provided which comprises a first carrier material with a modified bitumen, wherein the first carrier material is coated or saturated with the modified bitumen. The layered material can further comprise a synthetic resin. The layered material further comprises a second carrier material. The first carrier material and the second carrier material are continuously attached to each other, directly or indirectly. The first carrier material and second carrier material can, for example, form a composite material. According to the present invention, the modified bitumen is a bitumen to which an agent selected from the group consisting of wax, silicone oil, stearic acid, alkene ketene dimer (AKD), alkenyl succinic anhydride (ASA) and mixtures thereof has been added.

Under the term “continuously attached” according to the present invention is to be understood that substantially the entire surface of the first carrier material is attached to the surface of the second carrier material. An example of continuous attachment is adhering the full area of the surface of the first carrier material to the full area of the surface of the second carrier material. The attachment can be provided directly or indirectly, for example, by using an intermediate layer which continuously adheres to both the first carrier material and the second carrier material.

When coated or saturated onto the first carrier material the modified bitumen at least partly penetrates into the carrier material. It is possible, for example, to transfer any desired additives optionally contained in the modified bitumen into the carrier material by way of penetration of the modified bitumen into the first carrier material.

When attaching the first carrier material of the present invention to the second carrier material, for example, by hot pressing, at least parts of the modified bitumen, for example, penetrate into the second carrier material, which can, for example, be a wood product. Bitumen can penetrate along the wood grain pattern. Depending on the wood species, on the modified bitumen used, and on the processing conditions, the modified bitumen can, for example, penetrate 1 mm into birch or 3 mm into spruce wood products. A penetration depth of the modified bitumen into the second carrier material of, for example, at least 0.1 mm, for example, of at least 0.2 mm, for example, of at least 0.4 mm and, for example, of at least 0.5 mm is obtained. In an embodiment of the present invention, the penetration depth of modified bitumen into the second carrier material can, for example, be at least 1 mm, for example, at least 3 mm.

In an embodiment of the present invention in which the second carrier material is selected from a wood-based veneer, the penetration depth of the modified bitumen into the second carrier material can, for example, correspond to at least 10%, for example, to at least 25%, and, for example, to at least 50%, and in particular to at least 95% of the thickness of the second carrier material. In an embodiment of the present invention, the penetration depth of the modified bitumen into the second carrier material selected from a wood-based veneer corresponds, for example, to at least 98% and, for example, to 100% of the thickness of the second carrier material, i.e., the modified bitumen even penetrates 100% of the second carrier material.

The term “composite material” designates a material formed by at least two constituent materials. The composite material exhibits different physical or chemical properties like the separate constituting materials. After finishing, the composite material cannot be separated into the constituting materials without destruction. The constituting materials thus form a new entity.

The term “hot pressing” is well known to the person skilled in the art and generally refers to the concomitant application of heat and pressure. According to the present invention, hot pressing can, for example, refer to the concomitant application of pressures between 3 bar and 35 bar, for example, of between 5 bar and 25 bar, along with temperatures of between 90° C. and 400° C., for example, of between 100° C. and 200° C.

The terms “coating” and “saturating” are also known to the person skilled in the art. Coating can, for example, mean the application of a composition which forms a layer on the material to be coated, for example, the first carrier material. The composition which is applied can, for example, thus essentially remains on the surface of the material to be coated. Coating can, for example, mean that less than 40% by weight, for example, less than 35% by weight, for example, less than 30% by weight, and, for example, less than 20% by weight of the composition penetrates into the material to be coated. With the coating, for example, with the formed layer, for example, at least 5 g/m², in particular at least 8 g/m² and, for example, at least 10 g/m² in a weight per unit area of composition may be applied onto one side or on one side and the opposite side of the material onto which the coating is to be applied.

“Saturation” with a composition can, for example, mean that the material to be saturated is brought into contact with the composition, wherein the composition essentially penetrates into the material to be saturated, i.e., essentially does not remain on the surface of the material. Saturating can, for example, mean that more than 60% by weight, for example, more than 65% by weight, for example, more than 70% by weight, and, for example, more than 80% by weight of the composition penetrates into the material to be saturated with the composition. For example, more than 90% by weight and, for example, more than 95% by weight penetrates into the material to be saturated with the composition. In particular, embodiments even between 98% by weight and 100% by weight of the composition penetrates into the material to be saturated. At least 15 g/m², in particular at least 20 g/m² in a weight per unit area of composition is applied, for example, to one side or to said side and the opposite side of the material to be saturated with the composition, for example, to one side of the material.

“Bitumen” as used according to the present invention is a generic term for oil based semi-solid hydrocarbon products produced by removing the lighter fractions (such as liquid petroleum gas, petrol and diesel) from heavy crude oil during the refining process (distillation). The term “bitumen” thus always designates a composition, for example, in form of a solution. The bitumen used according to the present invention may be selected from the group consisting of hard bitumen, soft bitumen, straight run bitumen, high-vacuum bitumen, industrial bitumen, blown bitumen, blended bitumen, penetration bitumen, and any mixtures thereof.

Unless otherwise explicitly indicated, the term bitumen also encompasses “bituminous products”, “bitumen preparations” and “bitumen emulsions”. Bituminous products and bitumen preparations include cut-back bitumen and fluxed bitumen. Cut-backs are bitumen preparations in which the viscosity of the binder has been reduced by the addition of a volatile solvent, normally derived from petroleum. The solvents typically used are white spirit and kerosene. Fluxed bitumens are bitumen preparation where the viscosity of the binder has been reduced by the addition of relatively non-volatile oils. Typical fluxants include gas oil and vegetable based oils. Bitumen emulsions are products in which droplets (the dispersed phase) of bitumen are dispersed in an aqueous medium (the continuous phase). The bitumen particle charge can be positive (cationic), negative (anionic), or uncharged (non-ionic) depending on the emulsifier employed. Bitumen preparations also encompass products whereby the bitumen is diluted in an organic solvent. When using an emulsifier, the emulsifier can, for example, be selected so that it does not have any negative effect on hygroscopicity of the first and/or the second carrier material. The bitumen can, for example, be a blown bitumen.

According to the present invention, the bitumen is modified. The term “modified bitumen” according to the present invention refers to a bitumen, in which an agent selected from the group consisting of wax, in particular paraffin, silicone oil, stearic acid, alkene ketene dimer (AKD), alkenyl succinic anhydride (ASA), and mixtures thereof is added. Bitumen is hence modified by the inclusion, i.e., addition of at least one of the agents. Modified bitumen according to the present invention consequently includes, in particular consists of, a bitumen and at least one of the agents. The inclusion of at least one of these agents unexpectedly allowed for handling and application characteristics and physical properties of the resulting modified bitumen which are especially suitable for treating or processing wood products resulting in superior surface properties of the resulting wood products. A modified blown bitumen can, for example, be used.

The amount of the agent added in the bitumen can, for example, amount to at least 0.5% by weight, for example, at least 1% by weight, for example, at least 1.5% by weight, for example, at least 1.8% by weight, and, for example, at least 2% by weight based on the amount of the modified bitumen. The amount of agent added in bitumen can, for example, be at most 40% by weight, for example, at most 20% by weight, and, for example, at most 15% by weight, for example, at most 12% by weight, for example, at most 10% by weight based on the amount of the modified bitumen. In an embodiment, the amount of the agent can, for example, be between 1% by weight and 20% by weight, for example, between 1.8% by weight and 15% by weight, and, for example, between 2% by weight and 10% by weight based on the amount of the modified bitumen. The amount of stearic acid can, for example, be between 2% by weight and 20% by weight, for example, between 2% by weight and 5% by weight, for example, 2% by weight based on the amount of the modified bitumen. The amount of silicone oil can, for example, be between 2% by weight and 20% by weight, for example, between 2% by weight and 5% by weight, in particular 2% by weight based on the amount of the modified bitumen. The amount of AKD can, for example, be between 2% by weight and 20% by weight, for example, between 10% by weight and 20% by weight, in particular 10% by weight based on the amount of the modified bitumen. The amount of ASA can, for example, be between 2% by weight and 20% by weight, for example, between 10% by weight and 20% by weight, in particular 10% by weight based on the amount of the modified bitumen.

In an embodiment, bitumen can, for example, be modified by the addition of wax which can, for example, be added in an amount of from 5% by weight to 20% by weight, in particular of 5% by weight, 7% by weight, 10% by weight, 14% by weight or 20% by weight based on the amount of the modified bitumen. In an embodiment, bitumen can, for example, be modified by the addition of AKD, for example, AKD is added to bitumen in an amount of 10% by weight based on the amount of the modified bitumen. In still another embodiment, bitumen can, for example, be modified by the addition of silicone oil, for example, silicone oil is added to bitumen in an amount of 2% by weight based on the amount of the modified bitumen. In an embodiment, bitumen can, for example, be modified by the addition of ASA, for example, ASA is added to bitumen in an amount of 10% by weight based on the amount of the modified bitumen. In still another embodiment, bitumen can, for example, be modified by the addition of stearic acid, for example, stearic acid is added to bitumen in an amount of 2% by weight based on the amount of the modified bitumen.

In an embodiment, the bitumen can, for example, be modified by adding a wax, for example, paraffin, AKD, silicone oil, stearic acid or mixtures thereof, for example, by adding paraffin, AKD, silicone oil, stearic acid or mixtures thereof, and, for example, by adding paraffin, stearic acid or mixtures thereof. In particular embodiments, the bitumen can, for example, be modified by adding between 5% by weight and 20% by weight of paraffin based on the amount of the modified bitumen or 2% by weight to 5% by weight of stearic acid based on the amount of the modified bitumen.

The bitumen can, for example, be modified by the addition of a wax, for example, modified by the addition of paraffin, for example, paraffin in an amount of from 2% to 20% by weight, in particular of 5% to 15% by weight based on the amount of the modified bitumen. The inventors have found that by using paraffin as an agent to be added to bitumen, especially suitable properties of bitumen including softening point and penetration behavior can be obtained. This can allow for further facilitation of processing and further improvement of surface properties.

The amount of wax, for example, paraffin, can, for example, be at least 2% by weight, for example, at least 4% by weight and, for example, at least 5% by weight based on the amount of the modified bitumen. For example, at most 30% by weight and at most 20% by weight based on the amount of the modified bitumen of wax, for example, paraffin, is used in the modified bitumen. For example, at most 10% by weight of wax, for example, paraffin, is used in the modified bitumen. In an embodiment the wax, for example, paraffin, is present in an amount of between 4% by weight and 20% by weight, for example, of between 5% by weight and 15% by weight and, for example, of between 5% by and 10% by weight based on the amount of the modified bitumen. Application of wax, in particular paraffin, in such amounts can allow for layered materials with further improved water resistance and surface properties.

Bitumen can also be specified according the DIN norm EN 12591 (version 2009-08). Based on said DIN norm, the bitumen can be classified according to its penetration limits and linked to a specific value of needle penetration. For a needle penetration of 0.1 mm, measured according to DIN EN 12591, the following bitumen grades are known to the skilled person and respective bitumen and/or modified bitumen can be used for the present invention: 250/300, 160/220, 100/150, 70/100, 50/70, 40/60, 35/50, 30/45 and 20/30. The modified bitumen according to the present invention can, for example, exhibit a softening temperature range of 8° C. In an alternative embodiment, the modified bitumen is restricted to a softening temperature range of 6° C.

In an embodiment of the present invention, the modified bitumen can, for example, have a softening point between 70° C. and 145° C., for example, between 80° C. and 120° C., for example, of 120° C. or, alternatively, between 90° C. and 100° C.

The modified bitumen can, for example, be applied as molten modified bitumen. The molten modified bitumen can, for example, be heated for the application to the first carrier material to a temperature of between 70° C. to 300° C., for example, between 100° C. and 250° C. and, for example, between 125° C. and 250° C. The modified bitumen can alternatively be applied to the first carrier material in form of a solution with an organic solvent or as an emulsion (cf. supra).

The modified bitumen can, for example, be applied to the first carrier material in a weight per unit area between 10 and 100 g/m². The modified bitumen can, for example, be applied to the first carrier material in a weight per unit area of between 20 g/m² and 100 g/m², for example, of between 20 g/m² to 80 g/m², for example, of between 30 g/m² to 70 g/m² and, for example, of between 30 g/m² to 50 g/m².

The first carrier material is saturated or coated with the modified bitumen. In one embodiment, the first carrier material can, for example, be coated with the modified bitumen, wherein the coating is applied to one side of the first carrier material. Alternatively, the coating is applied to the one side and, additionally, to the opposite side of the first carrier material. The first carrier material may be saturated with resin before being coated with bitumen. In such embodiments, the first carrier material is at first saturated with a resin and in a second step is coated with the modified bitumen.

In an embodiment, the first carrier material can, for example, be saturated with the modified bitumen. The first carrier material can, for example, be saturated with the modified bitumen by applying the modified bitumen to one side of the first carrier material. In an embodiment, the modified bitumen does not, for example, penetrate to the opposite side of the first carrier material, i.e., no modified bitumen is present on the opposite side. Alternatively, the modified bitumen penetrates into the first carrier material so that the modified bitumen is also present on the opposite side. Saturation can, for example, be performed with between 30 g/m² to 70 g/m², for example, with between 30 g/m² to 50 g/m², for example, with between 35 g/m² to 40 g/m² and, for example, with 35 g/m² of the modified bitumen.

A “carrier material” as used in the present invention is any material than can be coated or saturated with the modified bitumen and resin. The carrier material may generally be selected from the group consisting of paper, in particular kraft paper or sack paper, card board, glass fiber, textiles including woven and non-woven fabrics, plastics including rigid foam and foam plastic, mineral material such as ceramics or cellular concrete, metal such as metal foils, wood products, such as wood-based panels. A carrier material according to the present invention may thus consist of or comprise a material which is selected from the group consisting of paper, kraft paper, sack paper, glass fiber, card board, textile fabrics including woven and non-woven fabrics, plastics including rigid foam and foam plastic, mineral material such as ceramics or cellular concrete, metal such as metal foils, wood, wood-based panel or wood composite.

A carrier material as used in the present invention can, for example, constitute a carrier layer, i.e., the first carrier material and/or the second carrier material can, for example, be present in form of a carrier layer, for example, the first carrier material and the second carrier material are present in form of a carrier layer each. The first carrier materials and the second carrier material can, for example, consist of different materials. The first carrier materials can, for example, be paper, for example, kraft paper, and the second carrier materials can, for example, be a wood-based panel or a wood-based veneer.

The first carrier material can, for example, be a paper, in particular kraft paper.

As used herein, the term “paper” is defined as a layered material mainly constituted of fibers, in particular derived from plants, in particular wood or grasses, or textiles. The paper can, for example, be kraft paper. According to the present invention, the paper can, for example, have a weight per unit area of between 40 g/m² and 250 g/m².

In an embodiment, the first carrier material, in particular a kraft paper, has a weight per unit area between 50 g/m² and 200 g/m², for example, between 60 g/m² and 125 g/m² and, for example, of 80 g/m² or 110 g/m², in particular of 110 g/m².

The second carrier material can, for example, be a wood product, such as a wood-based panel, wood-based veneer including a veneer sheet or a wood composite, for example, a wood-based panel or a wood-based veneer, in particular a wood-based panel. The wood-based panel may in particular be a birch or spruce plywood.

According to the present invention, the term “wood product” generally refers to any product formed comprising wood-based materials. Examples include wood-based veneers and wood-based panels. The wood-based panel includes wood, plywood, chipboard, fiber board, oriented strand board (OSB), glue wood, laminated veneer lumber (LVL), parallel strand lumber (PSL), oriented strand lumber (OSL), 3-layer boards or the like.

Within the present invention, the term “veneer” is defined as a layer with a thickness of usually not more than 2 cm or less, for example, 1.5 cm or less, for example, 1 cm or less, for example, less than 0.6 cm. Veneer typically has a minimal thickness of 0.1 cm. However, veneers with a thickness of about 0.1 mm also exist. A veneer can be of any material, in particular of wood, paper metal or plastic. The veneer can, for example, be a wood product (“wood-based veneer”).

As mentioned above, the layered material according to the present invention optionally comprises a synthetic resin. The term “resin” or “synthetic resin”, respectively, as used according to the present invention is a generic term for synthetic substances given as liquids that can be cured or hardened into solids. Unless otherwise explicitly mentioned hereinafter, the term “resin” is understood as “synthetic resin”. Accordingly, the terms “resin” and “synthetic resin” are used as synonyms in the context of the present invention. Unless otherwise explicitly indicated, this term encompasses “resin compositions”, “unmodified or modified resins”, thermoplastic resins and thermosetting resins. Resins used according to the present invention can, for example, be thermosettings. The resin can, for example, be a thermosetting resin. A “thermosetting resin” is usually defined as a substance or composition that changes irreversibly into an infusible, insoluble polymer network by curing. In contrast, thermoplastics are usually defined as plastic materials, typically polymers, that become pliable or moldable above a specific temperature and which solidify upon cooling.

Thermosetting resins include formaldehyde-based resins, acetal resins, polyester resins, vinylesters, acrylic resins or epoxy resins. The thermosetting resin may be an unmodified or a modified resin. For example, the melamine-formaldehyde resin may be modified, for example, by glycol, caprolactam, acetoguanamine, benzoguanamine or p-toluene-sulphonamide, by alkylation or etherification.

The thermosetting resin can, for example, be a formaldehyde-based resin. The formaldehyde-based resin can, for example, be selected from the group consisting of melamine-formaldehyde resin (MF), phenol-formaldehyde resin (PF), urea-formaldehyde resin (UF), melamine-urea-formaldehyde resin (MUF), phenol-resorcinol-formaldehyde (PRF) or a combination thereof. The thermosetting resin can, for example, be selected from MF, PF, a MF-PF blend, a PF-UF blend, a MUF, and mixtures thereof. The use of melamine-formaldehyde resin (MF) or a phenol-formaldehyde resin (PF) or mixtures thereof can, for example, be used, as can a PF resin.

The PF resin may be modified, for example, by urea, melamine, lignin, resorcinol, modified phenol, cresol, bisphenol or by other equivalent compound. Any amino and phenolic resins known per se may be used for the formaldehyde-based resins. By combining different types of resins, for example, phenolic and amino resins, together in a suitable ratio, it is possible to improve and optimize the properties of the resin. In the resin mixture, any solvent in which the resin is soluble may be used as the solvent for the resin.

The resin composition used can contain additives, for example, selected from the group consisting of wax, surfactants, softeners, hardeners, wetting agents, anti-foam agents, diluents and/or alkali or mixtures thereof.

In an embodiment of the present invention, the resin can, for example, be applied onto the first carrier material, for example, in form of a resin layer. In this embodiment of the present invention, the layered material can, for example, comprise at least one resin layer applied onto the first carrier material. The at least one resin layer can, for example, represent an outermost layer of the layered material. The first carrier material then constitutes an intermediate layer between the second carrier material and the resin layer.

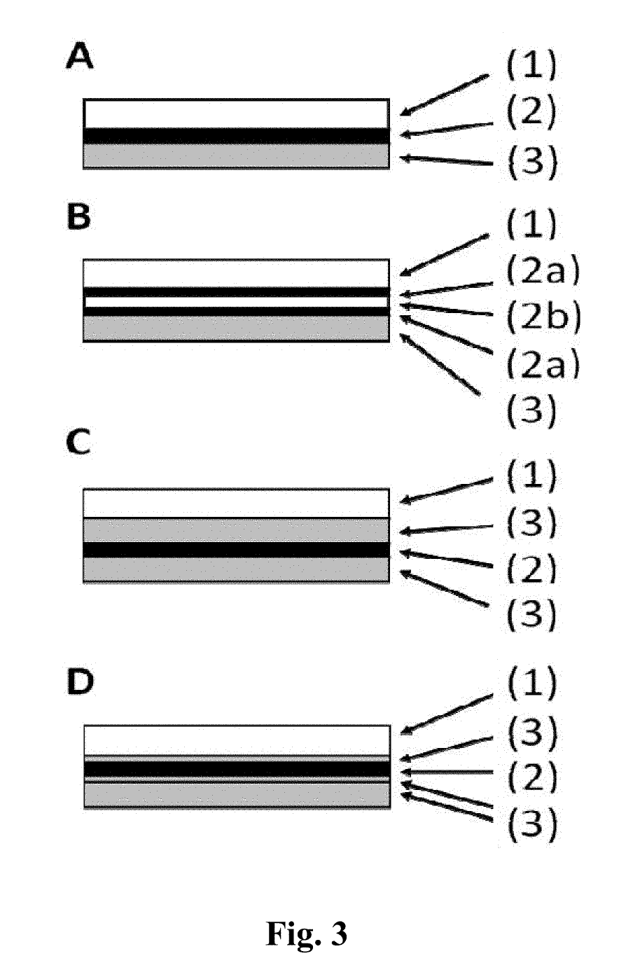

In an embodiment of the present invention, the layered material can, for example, comprise and can, for example, consist of the following layers: second carrier material, intermediate layer of first carrier material saturated with the modified bitumen, and resin layer as outermost layer (see FIG. 3).

In an embodiment of the present invention, the layered material can, for example, comprise, and can, for example, consist of the following layers: second carrier material, intermediate layer of first carrier material coated with the modified bitumen, and resin layer as outermost layer (see FIG. 3).

In an embodiment of the present invention, the resin is applied to both sides of the first carrier material with the modified bitumen resulting in a layered material can, for example, comprise, or can, for example, consist of the following layers: second carrier material, resin layer, layer of first carrier material saturated with the modified bitumen, and further resin layer as outermost layer (see FIG. 3).

In an embodiment of the present invention, the resin can, for example, be applied to both sides of the first carrier material with the modified bitumen, wherein a further resin layer is attached forming the outermost layer of the layered material, resulting in a layered material comprising or consisting of the following layers: second carrier material, resin layer, layer of first carrier material saturated with the modified bitumen, resin layer, and further resin layer as outermost layer (see FIG. 3). The resin layers forming intermediate layers can, for example, comprise an amount of between 10 g/m² to 15 g/m² resin in a weight per unit area, wherein the resin layer representing the outermost layer comprises an amount of between 120 g/m² and 140 g/m² of resin.

In an embodiment, the layered material can, for example, comprise and, can, for example, consist of the following layers: second carrier material and layer of first carrier material, which is saturated with resin and further coated with the modified bitumen.

It is notable that, even in embodiments of the present invention having no resin layer between the first carrier material and the second carrier material, further improved surface properties, in particular improved adhesion, were observed.

In an embodiment, the resin can, for example, be applied to the first carrier material, for example, saturated with the modified bitumen, in a weight per unit area between 75 g/m² and 300 g/m², for example, between 100 g/m² and 250 g/m² and, for example, between 110 g/m² and 250 g/m², in particular between 120 g/m² and 240 g/m². Such amounts of resin further contribute to high service durability of the resulting layered material and facilitate processing and handling.

The resin layer can, for example, comprise or consist of a resin. In an embodiment, the resin layer comprises paper, for example, kraft paper, which is saturated or coated with the resin. In this embodiment, the paper, for example, kraft paper, has a weight per unit area of between 30 g/m² and 250 g/m², for example, of between 35 g/m² and 125 g/m² and, for example, of between 40 g/m² and 100 g/m². The resin can, for example, be applied to the paper in a weight per unit area of between 60 g/m² and 200 g/m², for example, of between 70 g/m² and 170 g/m² and, for example, of between 80 g/m² and 160 g/m². In an embodiment, the resin layer can, for example, comprise a paper with a weight per unit area of 40 g/m² and resin applied to the paper in a weight per unit area of 80 g/m². In an embodiment, the resin layer can, for example, be a resin film consisting of resin and optionally additives.

The layered material according to the present invention may contain more than one resin layer, for example, one resin layer. In alternative embodiments of the present invention, the layered material can, for example, comprise at least two resin layers, for example, two resin layers or three resin layers, in particular three resin layers. In embodiments, in which the layered material of the present invention comprises at least two resin layers, the resin layers can comprise the same or, alternatively, different resins. With these at least two resin layers, the same amount of resin can be applied with each layer or, alternatively, the layers can comprise different amounts of resin. The at least two, for example, three, resin layers comprise different amounts of resin. At least one resin layer can, for example, comprise in a weight per unit area between 75 g/m² and 300 g/m², for example, between 100 g/m² and 250 g/m² and, for example, between 110 g/m² and 250 g/m², in particular between 120 g/m² and 240 g/m² of resin; wherein at least one of the other resin layers present in the layered material comprises in a weight per unit area between 5 g/m² and 40 g/m² resin, for example, between 8 g/m² and 20 g/m² resin and in particular between 10 g/m² and 15 g/m² of resin. In an embodiment of the present invention, three resin layers can, for example, be present within the layered material, wherein one resin layer comprises between 110 g/m² and 250 g/m², in particular between 120 g/m² and 240 g/m² of resin, which can, for example, represent the outermost layer of the layered material according to the present invention. In this embodiment, the remaining two resin layers, which can, for example, be present as intermediate resin layers, comprise in a weight per unit area between 8 g/m² and 20 g/m² resin and in particular between 10 g/m² and 15 g/m² of resin. In one particular embodiment of the present invention, the resin on the first carrier material can, for example, be cured, for example, completely cured, before the second carrier material, in particular a wood product, for example, a veneer, is attached to the first carrier material. A curing prior attaching the second carrier material, for example, the wood product, avoids extensive absorption of the resin into the second carrier material. The cured resin may establish the formation of an adhesive bond between the first carrier material and the second carrier material.

According to the present invention, the modified bitumen and the resin may be applied onto the first carrier material (cf. supra) together or separately. In a simplest embodiment of the present invention, the layered material thus encompasses a first carrier material saturated with the modified bitumen and/or resin or having a layer which is formed by a composition of the modified bitumen and resin having been applied onto the first carrier material. According to this embodiment of the present invention, the layered material thus comprises a first carrier material saturated with the modified bitumen and resin or coated with a layer comprising the modified bitumen and resin, the first carrier material being continuously directly or indirectly attached to a second carrier material. Both the modified bitumen and resin can, for example, be applied to the first carrier material in a molten state or as a solution.

The modified bitumen and the resin are alternatively applied onto the first carrier material separately. The carrier material can, for example, first be coated or saturated with the modified bitumen and, in a second step, is further coated or saturated with resin. In this embodiment, the layered material comprises the carrier material saturated with the modified bitumen and optionally further saturated with a resin or a carrier material saturated with the modified bitumen or coated with the modified bitumen and with a further resin layer. The carrier material can alternatively first be saturated with the resin and, in a second step, coated with the modified bitumen.

This first carrier material is attached to the second carrier material in order to form the layered material of the present invention. This can be accomplished in a manner known per se, for example, by a hot pressing or a hot-roller.

In an embodiment of the present invention, the first carrier material can, for example, comprise or consist of a carrier material which is coated or saturated on one side with the modified bitumen, and which is further coated or saturated with a resin such as an adhesive resin.

In an embodiment of the present invention, the first carrier material can, for example, comprise or consist of a carrier layer consisting of paper, for example, with a weight per unit area of between 60 g/m² and 125 g/m², which is coated or saturated with the modified bitumen, for example, with a weight per unit area of between 30 g/m² and 50 g/m², and which is further coated with a resin, for example, with a weight per unit area of between 110 g/m² and 250 g/m².

In an embodiment of the present invention, the first carrier material can, for example, comprise or consist of a carrier layer, for example, a paper or kraft paper, which is coated or saturated on one side with a resin, and which is coated or saturated on the opposite side with the modified bitumen, for example, with a weight per unit area of between 30 and 50 g/m².

In an embodiment of the present invention, the first carrier material can, for example, comprise or consist of a carrier layer, for example, paper or kraft paper, which is coated or saturated with the modified bitumen on each side, wherein a resin coated or saturated on one of the bitumized sides is further present, which can, for example, thereby form the outermost layer.

In an embodiment of the present invention, the first carrier material can, for example, comprise or consist of a carrier layer, for example, paper or kraft paper, which is coated or saturated with the modified bitumen on each side of the carrier layer, wherein a resin coated or saturated on each bitumized side is further present, for example, forming two outermost layers therewith.

In an embodiment of the present invention, the first carrier can, for example, be attached to a wood product, such as a veneer or a wood-based panel. The attachment/bonding between the wood product and the layered material may be achieved via the resin, for example, an adhesive resin, of the layered material.

A specific embodiment of the invention is therefore a kraft paper saturated with the modified bitumen (in particular a molten modified bitumen), which is furthermore coated on its bitumized side with a phenolic resin. The resulting layered material (first carrier material) is then hot-pressed onto a wood product, for example, a wood-based panel (second carrier material).

In an embodiment of the present invention, the layered material can, for example, comprise or consists of:
a) a second carrier material;
b) optionally a resin layer as intermediate layer between the second carrier material a) and the first carrier material c);
c) a first carrier material coated or saturated with the modified bitumen, as an intermediate layer between resin layer b) or second carrier material a) and the resin layer d); and
d) optionally at least one resin layer, for example, as an outermost layer applied to the first carrier material saturated or coated with the modified bitumen of c).

Further layers may be present within the layered material according to the present invention including “additional carrier layers” or “hydrophobic layers”. In embodiments of the present invention, an additional carrier layer or a hydrophobic layer is applied to the first carrier material of c) or the resin layer of d).

The hydrophobic layer may comprise or consist of a compound selected from the group consisting of wax, oils, fats, fatty acids, alkanes, alkenes and their derivates and mixtures thereof, in particular a compound selected from the group consisting of silicone oil, paraffin, stearin, stearic acid, alkene ketene dimer (AKD), alkenyl succinic anhydride (ASA), tall oil fatty acid and mixtures thereof. The hydrophobic layer in particular comprises or consists of paraffin or alkene ketene dimer (AKD). Suitable additional carrier layers comprise and, in particular, consist of paper such as kraft paper, which is optionally saturated with a resin.

In an embodiment, the additional carrier layer, which is paper, in particular kraft paper, is applied to that side of the first carrier material of c) which is coated with the modified bitumen, wherein the additional carrier layer may further be saturated with a resin or further be coated with a resin layer of d). In an embodiment, a hydrophobic layer consisting of wax is applied to that side of the first carrier material of c) which is coated with the modified bitumen. In said embodiment, the first carrier material can, for example, be saturated with a resin.

In an embodiment of the present invention the layered material can, for example, comprise or consist of:
a) a second carrier material which is a wood-based panel or a wood-based veneer;
b) a first carrier material, which is a paper and which is saturated with between 30 g/m² and 50 g/m² of the modified bitumen, as intermediate layer between the second carrier material a) and resin layer c); and
c) a resin layer, wherein the resin is selected from the group consisting of a melamine-formaldehyde resin (MF), a phenol-formaldehyde resin (PF), an urea-formaldehyde resin (UF), a melamine-urea-formaldehyde resin (MUF), a phenol-resorcinol-formaldehyde (PRF), and a combination thereof.

In an embodiment with respect to the present invention, the layered material can, for example, comprise or consist of:
a) a second carrier material consisting of a wood-based panel or a wood-based veneer;
b) a first carrier material saturated with between 30 g/m² and 50 g/m² of the modified bitumen, as intermediate layer between the second carrier material a) and resin layer c), wherein the first carrier material is kraft paper having a weight per unit area of between 60 g/m² to 125 g/m², wherein the modified bitumen is a modified blown bitumen, and wherein the blown bitumen is modified by addition of between 4% by weight and 20% by weight of paraffin based on the amount of the modified bitumen; and
c) a resin layer, wherein the resin is applied to the first carrier material saturated with bitumen of b) in a weight per unit area between 110 g/m² and 250 g/m², and wherein the resin is selected from melamine-formaldehyde resin (MF), a phenol-formaldehyde resin (PF), a MF-PF blend, a PF-UF blend and a melamine-urea-formaldehyde resin (MUF), and mixtures thereof.

The first carrier material is coated or saturated with the modified bitumen, for example, saturated, and optionally coated or saturated with a resin. The modified bitumen and optionally the resin can be mixed before being coated onto the first carrier material. In this embodiment according to the present invention, the modified bitumen and the resin are applied onto the carrier material as one composition in a single-step-process, for example, both are present in a liquid form, in particular in a molten state or as a solution.

In an alternative embodiment with respect to the present invention, the first carrier material is at first coated or saturated with the modified bitumen and, in a second step, further coated or saturated with the resin. The first carrier material can, for example, first be saturated with the modified bitumen and, in a second step, be further coated with the resin. In this embodiment, the first carrier material with the modified bitumen and resin are provided and applied in separate processes, i.e., in a two-step process. According to this embodiment of the present invention, the modified bitumen and resin are applied separately to the first carrier material.

The modified bitumen and/or optionally the resin can be applied onto the first carrier material in a manner known per se, for example, by a hot pressing or by a hot-roller.

The process for preparing a layered material of the present invention comprises the following steps:
a) providing a first carrier material, for example, in form of a carrier layer;
b) coating or saturating the first carrier material with the modified bitumen and optionally resin, wherein the modified bitumen can, for example, be in a liquid form, for example, as a molten modified bitumen, to form a bitumized first carrier material; and
c) applying the material from step b) to a second carrier material by heat and pressure, for example, by a hot pressing.

Step c) can, for example, be performed at a temperature of between 100° C. and 200° C., for example, of between 110° C. and 180° C., for example, between 120° C. and 150° C., and, for example, at 135° C. The pressure applied in step c) can, for example, be between 5 bar and 25 bar, for example, between 7 bar and 22 bar, and, for example, between 9 bar and 20 bar. By using temperatures or pressures which are too low, the resulting layered material may not provide the desired surface properties and an insufficient penetration of bitumen may be observed.

Temperature and pressure can, for example, be applied for at least 1 minute up to at most 20 minutes, for example, at least 2 minutes and at most 15 minutes, and, for example, at least 4 minutes and at most 10 minutes, in particular 5 minutes. In case the time period is too short, adhesion may be insufficient. To long processing may be accompanied by increased production costs and energy consumption. The same is true in case temperatures and pressures are used, which are too high.

The process for preparing a layered material of the present invention can, for example, comprise or consist of the following steps:
a) providing a first carrier material, for example, in the form of a carrier layer;
b) coating or saturating the first carrier material with the modified bitumen, wherein the modified bitumen can, for example, be in a liquid form, for example, a molten modified bitumen, to form a bitumized first carrier material;
c) optionally coating or saturating the bitumized first carrier material from step b) with a resin;
d) optionally curing the resin; and
e) applying the material from step b) or the material from step c) or d) to a second carrier material by heat and pressure, for example, by a hot pressing. The material from step c) or d) may be applied to the second carrier material with that side of the bitumized first carrier material that has not been coated or saturated with the resin or, alternatively, with that side of the bitumized first carrier material that has been saturated or coated with the resin. The material from step c) or d) can, for example, be applied to the second carrier material with that side of the bitumized first carrier material that has not been coated or saturated with the resin.

The modified bitumen of step b) and the resin layer of step c) may be applied in different steps using the same impregnation machine. In an alternative embodiment, these steps can, for example, be performed by separate impregnation machines.

Step e) can, for example, be performed at a temperature of between 100° C. and 200° C. The pressure can, for example, be between 5 and 25 bar. Temperature and pressure can, for example, be applied for 1 minute to 20 minutes. Step e) can, for example, be performed at a temperature of between 110° C. and 180° C., for example, between 120° C. and 150° C. and, for example, at 135° C. The pressure applied in step e) can, for example, be between 7 bar and 22 bar and, for example, between 9 bar and 20 bar. Temperature and pressure can, for example, be applied for at least 2 minutes and at most 15 minutes, for example, at least 4 minutes and at most 10 minutes.

In an embodiment with respect to the present invention, the process for preparing a layered material can, for example, comprise or consist of the following steps:
a) providing a first carrier material, for example, in the form of a carrier layer;
b) saturating the first carrier material with the molten modified bitumen to form a bitumized first carrier material;
c) coating the bitumized first carrier material from step b) with a resin;
d) optionally curing the resin; and
e) applying the material from step c) or d) with that side of the bitumized first carrier material that has not been coated with the resin to a second carrier material by heat and pressure, for example, by a hot pressing.

Step e) can, for example, be performed at a temperature of between 110° C. and 180° C. and a pressure of between 7 bar and 22 bar for 2 to 15 minutes.

In an embodiment with respect to the present invention, the process for preparing a layered material can, for example, comprise the following steps:
a) providing a first carrier material, for example in the form of a carrier layer;
b) saturating the first carrier material with the molten modified bitumen to form a bitumized first carrier material;
c) applying the material from step b) to a second carrier material by heat and pressure, for example, by a hot pressing;
d) coating the bitumized first carrier material from step c) with a resin; and
e) optionally curing the resin.

Step c) can, for example, be performed at a temperature of between 110° C. and 180° C. and a pressure of between 7 bar and 22 bar for 2 to 15 minutes.

The present invention further relates to a wood product comprising a layered material according to the present invention.

### Examples

### Example 1: Preparation and Testing of Surface Properties of Layered Materials According to the Present Invention

1.1 Objective

The objective was to test four different types of layered materials (layered materials A to D). All layered materials are in accordance with the present invention.

The layered materials are generated as follows:

First carrier material of all layered materials is 110 g/m² kraft paper, which has been saturated with blown modified bitumen (35 g/m²), wherein bitumen (Kerabit® BIL 20/85, Nordic Waterproofing Oy) has been modified by the addition of 7% by weight of paraffin based on the amount of the modified bitumen. The second carrier material consists of a wood-based panel:

Layered material A: 9 mm/7 ply birch plywood.

Layered material B: 9 mm/7 ply birch plywood.

Layered material C: 18 mm/6 ply spruce plywood.

Layered material D: 27 mm/3 ply 3-layer board.

Layered materials A, C and D were further coated with 220 g/m² phenolic layer consisting of a 80 g/m² paper saturated with 140 g/m² phenolic resin, wherein layered material B was further coated with 220 g/m² melamine layer consisting of a 80 g/m² paper saturated with 140 g/m² melamine resin given the following layered structure: panel-bitumized paper-phenolic or melamine layer.

The following temperature and pressure has been used when applying bitumized paper and resin layer to the second carrier material, wherein both were applied at the same time in a one-step process:

Layered material A: 18 kg/cm² (corresponds to about 17.7 bar)-6 min-135° C.

Layered material B: 18 kg/cm² (corresponds to about 17.7 bar)-6 min-135° C.

Layered material C: 16 kg/cm² (corresponds to about 15.7 bar)-6 min-135° C.

Layered material D: 12 kg/cm² (corresponds to about 11.8 bar)-6 min-135° C.

1.2 Test Setup

The following tests were conducted to determine surface properties of the layered materials:

Rippling Test

The rippling test is a test which describes the behavior of layered materials including coated panel surfaces when coating is damaged and exposed to moisture. The layered materials are allowed to cool down following their preparation before testing. The coating to be studied is artificially punctured by making holes of a defined size into the surface structures, i.e., into the coated first carrier material up to the second carrier material. These holes have depth of 0.5 mm, 1 mm and 1.5 mm. A completely wet paper towel or cloth is placed on top of holes so that holes are in fully covered with water. The paper towel/cloth is kept wet during the duration of test, i.e., 2 and 3 hours, respectively. When the test is completed, the paper towel/cloth is removed and surface wiped dry.

When water penetrates into wood, fibers swell causing a phenomenon called “rippling”. Rippling is evaluated by measuring the length of swollen fibers (whiskers) after a given test time. The obtained result is given as the length in mm of swelled wood grains around the hole: (diameter of the swelling area−diameter of the hole)=rippling result.

Boiling Test

A boiling test has been carried out with the samples including boiling for 2 hours and evaluating the surface properties of the layered materials including swelling of wood fibers, blisters, delamination and color changes.

Concrete Test

Cement is an alkaline material which etches surface structures if alkaline resistance or cure level is not sufficient.

The concrete test is carried out by mixing neat cement (standard Portland cement) with water so that a consistent paste is formed. The cement paste is poured into a plastic cup and placed onto the surface structure, i.e., the layered materials, to be studied. The cement paste is allowed to dry for three days and is then removed. When removing the cement cake, the following properties are evaluated: sticking of cement onto the surface of the layered materials (surface with the first carrier material and the resin), possible change in surface structure because of cement (swelling, cracking, color change).

Adhesion Test

This test is done with an Elcometer® 106 Pull Off Adhesion Tester and was carried out as follows:

An adhesion test dolly was bonded to the layered material (surface with the first carrier material and the resin) using an adhesive (2K epoxy). The adhesive is allowed to dry and cure for 24 hours. If necessary, the dolly and the surface are roughened with sand paper to ensure a good bond between adhesive and surface or dolly.

The Elcometer® 106 adhesion tester houses a spring arrangement which applies a lift force to the dolly as the tension is increased. When the coating is pulled off the surface, an indicator on the scale shows the numerical value of adhesion expressed in terms of the force per unit area required to remove the dolly (N/mm²). Inspection of the dolly face is required to determine the failure mode.

The following test conditions are used:
Either layered material after hot pressing when samples have been cooled down to room temperature (referenced to as “dry”); or
Layered material after boiling and subsequent drying (referenced to as “boiling and drying”), i.e., the samples are boiled for 2 hours and allowed to dry for a minimum of 24 hours.

Cracking Test

For this test, an additional coating is applied to the second carrier material as an outermost layer to avoid warping of samples during testing. The resulting samples are cut to a size of 100 mm×100 mm and the edges are sanded in order to remove possible cracks caused by machining tools. A minimum of three replicates are prepared.

The cracking test is a cyclic test consisting of the following cycles:
Water soak (20° C.) for 8 hours; and
Drying and heat treatment in hot (70° C.) oven for 16 hours.

After heat treatment, samples were allowed to cool at room temperature. Cracking (number of cracks, length of cracks) is evaluated after cooling. Test cycles are repeated as many times as needed to determine cracking tendency, i.e., cracking will not take place, layered material surface (surface without additional coating) is completely cracked or difference between test material and known reference is seen.

1.3 Results of Tests

The results of the tests carried out are set forth in Table 1.

As evident from Table 1, the test results reveal that there was no swelling after the concrete test and no bubbling after carrying out the boiling test. All layered materials also proved to provide good adhesion, i.e., adhesion values of between about 0.5 and 2.5 N/mm².

Significantly reduced swelling after the ripping test was observed compared to the swelling of birch plywood solely coated with 220 g/m² phenolic film (phenolic film, AnyPress®, which is approximately 100 mm. Cracking of layered materials C and D did not appear or the level was considered minimal which indicates a reduced stretching and contracting within the layered materials under the harsh conditions during the test.

Layered materials according to the present invention are therefore suitable to provide surface properties allowing for an enhanced service durability of respective wood products. It has also been shown that layered material according to the present invention are easy to coat and respective phenolic layer showed sufficient adherence.

TABLE 1
Results with Respect to Surface Properties

| | Layered Materials | | | | | | | |
|---|---|---|---|---|---|---|---|---|
| Test | A | | B | | C | | D | |
| Boiling test | no bubbles | | no bubbles | | no bubbles | | no bubbles | |
| Concrete test | no swelling | | no swelling | | no swelling | | no swelling | |
| Adhesion test | 1.6 | N/mm² | 0.8 | N/mm² | 0.7 | N/mm² | 1.1 | N/mm² |
| (dry) | | | | | | | | |

| | | | | | | | |
|---|---|---|---|---|---|---|---|
| Adhesion test | * | 1.0 | N/mm² | 0.4 | N/mm² | 1.5 | N/mm² |
| (boiling and | | | | | | | |
| drying) | | | | | | | |

| Cracking, 5 | not tested | | not tested | | None | Minimal** |
|---|---|---|---|---|---|---|
| cycles | | | | | | |
| Rippling, | 1*** = 13/10/10 mm | | 1 = 19/57/30 mm | | not tested | no tested |
| 2 hours | 2 = 12/10/7 mm | | 2 = 6/6/6 mm | | | |
| Rippling, | 97/39/13 | mm | 97/39/13 | mm | not tested | not tested |
| 3 hours | | | | | | |

* Test failed due to gluing of the test button.
**Gluing of layers started to fail during test causing one crack on sample.
***1 and 2 are replicate tests on same piece of plywood.

### Example 2: Preparation and Testing of Further Layered Materials According to the Present Invention

2.1 Objective

The objective was to test further types of layered structures (E to J). Layered materials F and G as well as I and J are in accordance with the present invention.

The layered materials were generated as follows:

The first carrier material of all layered materials was 110 g/m² kraft paper, which was saturated with blown modified bitumen (35 g/m²), wherein bitumen (Kerabit® BIL 20/85, Nordic Waterproofing Oy) was modified by the addition of paraffin in an amount of 7% by weight based on the amount of the modified bitumen. The second carrier material consisted of a wood-based panel, namely a 40×40 panel of either 9 mm birch or 18 mm spruce.

The following layered structures were prepared:

Layered structure E and H: 3 layers of 120 g/m² phenolic film.

Layered material F and I: bitumized paper-2 layers of 120 g/m² phenolic film.

Layered material G and J: layer of 120 g/m² phenolic film-bitumized paper-layer of 120 g/m² phenolic film.

Pressing conditions as mentioned in Example 1 were used.

2.2 Test Setup

The following tests were conducted to determine surface properties of the layered structures: Rippling test and adhesion test, which were carried out as described in Example 1.

2.3 Results of Tests

The results of the tests carried out are set forth in Table 2 and Table 3.

As evident from Tables 2 and 3, the test results reveal that there was a significant reduction of swelling observed for the layered materials according to the present invention. In contrast, in layered structures E and H, higher rate of swelling was measured. Still further, it is evident that adhesion is further increased in embodiments according to the present invention in which first carrier material adheres to second carrier material without a resin layer between both carrier materials. Inconsistent properties of wood may have contributed to the results measured for sample H.

TABLE 2
Results with Respect to Surface Properties - Panel of Birch

| | Layered Structures | | | | | |
|---|---|---|---|---|---|---|
| Test | E | | F | | G | |
| Adhesion test (dry) | >2.2 | N/mm² | 1.45 | N/mm² | 0.75 | N/mm² |
| Adhesion test | * | | 1.0 | N/mm² | 0.4 | N/mm² |
| (boiling and | | | | | | |
| drying) | | | | | | |
| Rippling, 2 hours | 90/42/22 | mm | 0/15/0 | mm | 16/0/2 | mm |

TABLE 3
Results with Respect to Surface Properties - Panel of Spruce

| | Layered Structures | | | |
|---|---|---|---|---|
| Test | | H | I | J |

| | | | | | | |
|---|---|---|---|---|---|---|
| adhesion test (dry) | >1.55 | N/mm² | 1.6 | N/mm² | 0.5 | N/mm² |
| Rippling, 2 hours | 11/11/0 | mm | 11/8/0 | mm | 0/9/4 | mm |

* Gluing failure of button.

### Example 3: Preparation and Testing of Further Layered Materials According to the Present Invention

3.1 Objective

The objective was to test further layered structures, wherein layered materials K and L are in accordance with the present invention.

The layered materials were generated as follows:

The first carrier material of all layered materials is paper, which was saturated with modified bitumen, wherein bitumen (Kerabit® BIL 20/85, Nordic Waterproofing Oy) was modified by addition of paraffin. The second carrier material consisted of a wood-based panel, namely birch plywood (7 ply, 9 mm birch plywood panel) or spruce plywood (6 ply, 18 mm spruce plywood panel). Further details of the three types of bitumen saturated paper selected for testing are presented in Table 4.

TABLE 4
Types of Bitumen Saturated Paper

| | | Paraffin in modified | |
|---|---|---|---|
| | Paper weight, | bitumen, in % by | Total weight of bitumen |
| Sample | in g/m² | weight | saturated paper, in g/m² |
| K | 80 | 5 | 127 |
| L | 80 | 10 | 117 |
| M | 80 | 0 | 148 |

Bitumen saturated paper types K to M were coated on both sides with alkaline phenol-formaldehyde resin. The resin coating was dried in a hot oven. The amount of resin was 10 to 15 g/m² (dry) on each side of the first carrier material saturated with bitumen. Resin coated, bitumen saturated paper samples were pressed on birch or spruce plywood onto the second carrier material by using the following pressing conditions (hot pressing) and placing a 120 g/m² resin layer (40 g/m² paper saturated with a phenolic resin to a total weight of 120 g/m²) on top of resin-bitumen paper. Pressing was carried out in one step:

Hot pressing conditions:
5 min-18 kg/cm² (i.e. about 17.7 bar)-135 C for birch plywood
5 min-14 kg/cm² (i.e. about 13.7 bar)-135 C for spruce plywood

3.2 Test Setup

The following tests were conducted to determine surface properties of the layered structures K to M: Panels were tested for rippling and adhesion as described in Example 1 with birch plywood and for adhesion with spruce plywood. Rippling and adhesion tests were carried out by pressing reference samples (220 g/m² phenolic surface film) side-by-side on the same piece of plywood. Rippling result is given and calculated as the reduction of rippling compared to reference sample on the same piece of plywood. Each type of bitumen saturated paper was tested with three different birch plywood samples, each sample having three individual rippling and adhesion measurements. Spruce plywood was tested with two different panels.

3.3 Results of Tests

The results of the tests carried out are presented in Table 5 and Table 6.

As evident from Tables 5 and 6, the test results reveal an exceptional reduction of rippling, i.e., swelling, by the use of the layered materials according to the present invention. Good adhesion was also measured, wherein a further increase in adhesion was obtained with type K with bitumen modified with an amount of 5% by weight of paraffin based on the amount of modified bitumen. Insufficient adhesion was measured for Tape M with spruce panel, i.e., an adhesion below 0.5 N/mm².

TABLE 5
Results with Respect to Surface Properties - Panel of Birch

| Type of bitumen | | | | Adhesion, |
|---|---|---|---|---|
| saturated paper | Sample | Rippling reduction, % | | N/mm² |
| K | 1 | 88.1 | average | 2.20 |
| K | 2 | 62.9 | value: | 2.40 |
| K | 3 | 82.3 | 77.76 | 2.43 |
| L | 1 | 82.1 | average | 1.60 |
| L | 2 | 73.1 | value: | 1.76 |
| L | 3 | 73.6 | 76.26 | 1.86 |
| M | 1 | 66.2 | average | 1.63 |
| M | 2 | 75.9 | value: | 1.56 |
| M | 3 | 77.2 | 73.1 | 1.53 |

TABLE 6
Results with Respect to Surface Properties - Panel of Spruce

| Type of bitumen | | | |
|---|---|---|---|
| saturated paper | Sample | Adhesion, N/mm² | Wood failure, % |
| K | 1 | 0.73 | 100 |
| K | 2 | 0.93 | 100 |
| L | 1 | 0.93 | 50 |
| L | 2 | 0.50 | 50 |
| M | 1 | 0.43 | 0 |
| M | 2 | 0.33 | 0 |

Wood failure is a common expression used in wood adhesion. 100% wood failure means that braking takes place within the wood, i.e., the bonding surface is fully covered with wood fibers. 0% wood failure means that braking takes place so that wood surface is practically unchanged. When wood failure is 100%, it is impossible to increase strength further because the failure continues to take place within the wood. High wood failure is generally considered good as it indicates that the “coating” strongly adheres to the wood product or that high adherence of coating is achieved. With birch, higher adhesion is obtained with the layered materials according to the present invention while having sufficient wood failure. With spruce, good adhesion was also obtained with the layered materials according to the present invention. There was no possibility to obtain further increased adhesion values because wood failure became the limiting factor, reaching 100%. These tests show that the type of bitumen paper has significant effect on properties and that good results are obtainable with the layered materials according to the present invention.

### Example 4: Preparation and Testing of Different Agents for Modification of Bitumen with Respect to Reduction of Rippling

4.1 Objective

The objective was to test different agents for modification of bitumen by testing the effect of these agents by means of applying respective modified bitumen directly on plywood surface.

Test samples were prepared as follows:
Panel of 9 mm birch plywood;
Composition to be studied, i.e., bitumen in which the agent was added, was applied onto the plywood surface in a quantity of between 40 g/m² and 50 g/m²;
The composition was applied as liquid and allowed to dry; and
220 g/m² resin layer (phenolic resin) was pressed on the treated surface (18 kg/cm², which corresponds to about 17.7 bar, for 5 min at 135° C.).

4.2 Test Setup

The rippling test was performed as described in Examples 1 to 3.

Bitumen was Kerabit® BIL 20/85 (Nordic Waterproofing Oy). Agents for modification of bitumen studied were paraffin (Sasol Wax 5205), alkene ketene dimer (AKD), alkenyl succinic anhydride (ASA), silicone oil and stearic acid. Rippling was measured as a duplicate of three holes of different size. Rippling result are given as percentage of reduction of rippling and average of all measurements.

4.3 Results of Tests

The results of the tests carried out are set forth in Table 7.

As evident from Table 7, the test results reveal a further reduction of rippling by the use of the agents tested. All agents performed well, wherein paraffin, stearic acid, AKD and silicone oil gave the best results, in particular 10% by weight of paraffin and 2% by weight of stearic acid based on the modified bitumen. The tests confirm that modification of bitumen by addition of the agents selected from paraffin, stearic acid, AKD, ASA and silicone oil allow for wood products having improved water resistance, i.e., reduced rippling.

TABLE 7
Results with Respect to Rippling

| | Parts of | | | | | | |
|---|---|---|---|---|---|---|---|
| | bitumen | | Parts | | | | |
| | (Kerabit | | of | Parts | Parts | Parts of | |
| | BIL | Parts of | silicone | of | of | stearic | Rippling |
| | 20/85)) | paraffin | oil | AKD | ASA | acid | reduction |
| Sample | (w/w) | (w/w) | (w/w) | (w/w) | (w/w) | (w/w) | in % |
| 1 | 98 | 0 | 2 | 0 | 0 | 0 | 51 |
| 2 | 90 | 0 | 10 | 0 | 0 | 0 | 47 |
| 3 | 98 | 0 | 0 | 2 | 0 | 0 | 41 |
| 4 | 90 | 0 | 0 | 10 | 0 | 0 | 51 |
| 5 | 98 | 0 | 0 | 0 | 2 | 0 | 27 |
| 6 | 90 | 0 | 0 | 0 | 10 | 0 | 33 |
| 7 | 98 | 0 | 0 | 0 | 0 | 2 | 75 |
| 8 | 90 | 0 | 0 | 0 | 0 | 10 | 32 |
| 9 | 90 | 10 | 0 | 0 | 0 | 0 | 70 |

The present invention is not limited to embodiments described herein; reference should be had to the appended claims

What is claimed is:

1-17. (canceled)

18: A layered material comprising:
a first carrier material which is coated or saturated with a modified bitumen, the modified bitumen being a bitumen to which is added an agent selected from the group consisting of a wax, a silicone oil, stearic acid, alkene ketene dimer (AKD), alkenyl succinic anhydride (ASA), and mixtures thereof; and
a second carrier material,
wherein,
the first carrier material is continuously attached to the second carrier material.

19: The layered material as recited in claim 18, wherein the first carrier material and the second carrier material form a composite material.

20: The layered material as recited in claim 18, whereas the modified bitumen has a softening point between 70° C. and 145° C.

21: The layered material as recited in claim 18, wherein,
the bitumen which is modified is selected from the group consisting of a hard bitumen, a soft bitumen, a straight run bitumen, a high-vacuum bitumen, an industrial bitumen, a blown bitumen, a blended bitumen, a penetration bitumen, and mixtures thereof, a bituminous product, a bitumen emulsion, and bitumen preparations thereof.

22: The layered material as recited in claim 18, wherein the agent is added in an amount of between 1 wt.-% and 20 wt.-% based on the weight of the modified bitumen.

23: The layered material as recited in claim 18, wherein,
the agent is the wax, and
the wax is added in an amount of between 4 wt.-% and 20 wt.-% based on the weight of the modified bitumen.

24: The layered material as recited in claim 18, further comprising:
a resin.

25: The layered material as recited in claim 24, wherein the first carrier material is coated or saturated with the resin.

26: The layered material as recited in claim 24, wherein the resin is selected from the group consisting of a melamine-formaldehyde resin (MF), a phenol-formaldehyde resin (PF), a blend of the melamine-formaldehyde resin (MF) and the phenol-formaldehyde resin (PF), a blend of the phenol-formaldehyde resin PF and an urea-formaldehyde resin (UF), a melamine-urea-formaldehyde resin (MUF), and mixtures thereof.

27: The layered material as recited in claim 18, wherein the first carrier material is a paper.

28: The layered material as recited in claim 18, wherein,
the first carrier material is a kraft paper, and
the second carrier material is a wood-based panel or a wood-based veneer.

29: The layered material as recited in claim 18, further comprising:
at least one first resin layer applied to the first carrier material of as an outermost layer.

30: The layered material as recited in claim 29, further comprising:
a second resin layer arranged between the first carrier material and the second carrier material.

31: The layered material as recited in claim 18, comprising:
a paper as the first carrier material;
a wood-based panel as the second carrier material; and
a resin layer selected from the group consisting of a melamine-formaldehyde resin (MF), a phenol-formaldehyde resin (PF), a blend of the melamine-formaldehyde resin (MF) and the phenol-formaldehyde resin (PF), a blend of the phenol-formaldehyde resin PF and an urea-formaldehyde resin (UF), a melamine-urea-formaldehyde resin (MUF), and mixtures thereof.

32: The layered material as recited in claim 31, wherein,
the paper as the first carrier material is a kraft paper having a weight per unit area of 60 g/m² to 125 g/m² which is coated or saturated with between 30 g/m² and 50 g/m² of the modified bitumen, and
the resin layer is applied to the kraft paper with a weight per unit area of between 110 g/m² and 250 g/m².

33: A method for preparing a layered material comprising:
a first carrier material which is coated or saturated with a modified bitumen, the modified bitumen being a bitumen to which is added an agent selected from the group consisting of a wax, a silicone oil, stearic acid, alkene ketene dimer (AKD), alkenyl succinic anhydride (ASA), and mixtures thereof; and
a second carrier material,
wherein,
the first carrier material is continuously attached to the second carrier material,
the method comprising:
providing the first carrier material;
coating or saturating the first carrier material with the modified bitumen to form a bitumized first carrier material; and
applying the bitumized first carrier material to the second carrier material via heat and pressure.

34: The method as recited in claim 33, wherein:
the first carrier material is provided in a form of a carrier layer,
the coating or saturating of the first carrier material further includes a resin,
the modified bitumen is provided as a molten modified bitumen, and
the applying of the bitumized first carrier material to the second carrier material via heat and pressure is performed via a hot-pressing.

35: The method as recited in claim 34, further comprising:
curing the resin,
wherein,
the applying of the bitumized first carrier material to the second carrier material via heat and pressure is performed at a temperature of between 100° C. and 200° C., a pressure of between 5 and 25 bar, for a time of between 1 minute and 20 minutes.

36: The method as recited in claim 35, wherein,
the temperature is between 110° C. and 180° C.,
the pressure is between 7 and 22 bar, and
the time is between 2 minutes and 15 minutes.

37: A wood product comprising the layered material as recited in claim 1.
